(19) United States
(12) Patent Application Publication
(10) Pub. No.: US 2005/0289599 A1
(43) Pub. Date: Dec. 29, 2005

(54) Information processor, method thereof, program thereof, recording medium storing the program and information retrieving device

(75) Inventors: Koji Matsuura, Tokorozawa-shi (JP); Harumi Nakamura, Tokorozawa-shi (JP); Tetsuya Kawahara, Tokorozawa-shi (JP); Wakako Nagata, Tokorozawa-shi (JP); Yukio Numkami, Tokorozawa-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: PIONEER CORPORATION, Tokyo (JP)

(21) Appl. No.: 11/141,196

(22) Filed: Jun. 1, 2005

(30) Foreign Application Priority Data
Jun. 2, 2004 (JP) 2004-164936

(51) Int. Cl. H04N 5/445; G06F 13/00

(52) U.S. Cl. 725/53; 725/52

(57) ABSTRACT

When a request for receiving or reproducing contents data of a TV program of a predetermined detail based on an input on an input unit 260 of a recording/reproducing device 200 is recognized, a related keyword related to a keyword as a searching request is recognized. Program information is narrowed, from program information including the keyword and the related keyword in accordance with a priority based on an appearance frequency as a history of the related keyword for the keyword. Since the detail of the detected program information corresponds to the priority, improper searching of the program information can be prevented, so that the program information can be selected appropriately, and proper contents data can be retrieved easily.

### BACKGROUND OF THE INVENTION

1. Field of the Invention

The present invention relates to an information processor for retrieving information of a predetermined detail based on detail information about a detail of the information by an information retriever, a method thereof, a program thereof, a recording medium storing the program and an information retrieving device.

2. Description of Related Art

Conventionally, as a recorder for recording a broadcast program, there has been known a device for automatically timer-recording a desired program. As such recorder, there has been known an arrangement for automatically recording a program corresponding to a keyword that is set by a user for a program desired to record, based on an electronic program guide about details of programs (see, for instance, Reference 1: Japanese Patent Laid-Open Publication No. 2003-288359).

In the arrangement disclosed in the Reference 1, a searching keyword for searching a broadcast contents desired by the user is retrieved from a user terminal, and a searching related keyword related to the searching keyword is retrieved from a searching keyword database in which a nickname, common name, abbreviatable name or the like is associated with a formal name. Then, through a matching with EPG data, contents information including a keyword matching with the searching keyword and the searching related keyword is displayed as a list.

However, in the conventional arrangement disclosed in the Reference 1, where the searching related keyword related to the keyword is also searched, since there are large number of candidates to be searched, an operation for specifying a broadcast program desired by the user becomes bothersome.

### SUMMARY OF THE INVENTION

An object of the present invention is to provide an information processor capable of appropriately retrieving predetermined information, a method thereof, a program thereof and a recording medium storing the program, and an information retrieving device.

An information processing method according to still another aspect of the present invention, in which a computing unit retrieves information of a predetermined detail based on detail information about a detail of the information by an information retriever, includes the steps: retrieving keyword information about a keyword corresponding to the predetermined detail included in request information for retrieving the information of the predetermined content by the request information retriever; recognizing related keyword information about a related keyword related to the keyword of the keyword information; recognizing priority information about a priority of the related keyword of the recognized related keyword information; searching, based on the recognized priority information, the detail information of the detail including at least one of the keyword of the keyword information in the request information and the related keyword of the recognized related keyword information in accordance with the priority; and controlling the information retriever to retrieve the information based on the searched detail information.

An information retrieving device according to another aspect of the present invention includes: the above-described information processor of the present invention; and an information retriever for retrieving the information.

An information processing method according to still another aspect of the present invention, in which a computing unit retrieves information of a predetermined detail based on detail information about a detail of the information by an information retriever, includes the steps: retrieving keyword information about a keyword corresponding to the predetermined detail included in request information for retrieving the information of the predetermined content by the request information retriever; recognizing related keyword information about a related keyword related to the keyword of the keyword information; recognizing priority information about a priority of the related keyword of the recognized related keyword information; searching, based on the recognized priority information, the detail information of the detail including at least one of the keyword of the keyword information in the request information and the related keyword of the recognized related keyword information in accordance with the priority; and controlling the information retriever to retrieve the information based on the searched detail information.

An information processing program according to yet another aspect of the present invention operates a processing unit to function as the above-described information processor of the present invention.

An information processing program according to further aspect of the present invention operates a processing unit to execute the above-described information processing method of the present invention.

A recording medium according to still further aspect of the present invention stores the above-described information processing program in a manner readable by the computing unit.

### BRIEF DESCRIPTION OF THE DRAWINGS

FIG. 1 is a block diagram briefly showing the arrangement of a recording/reproducing system in an information recorder according to an embodiment of the present invention;

FIG. 2 is a schematic diagram briefly showing the arrangement of a program information table of the embodiment;

FIG. 3 is a schematic diagram briefly showing the arrangement of a timer-recording list of the embodiment;

FIG. 4 is a schematic diagram briefly showing the arrangement of a contents management list of the embodiment;

FIG. 5 is a schematic diagram briefly showing the arrangement of keyword history information of the embodiment;

FIG. 6 is a schematic diagram briefly showing the arrangement of a CPU of the embodiment; and

FIG. 7 is a flowchart showing a flow of a timer-recording process of the embodiment.

### DETAILED DESCRIPTION OF PREFERRED EMBODIMENT(S)

An embodiment of the present invention will be described below with reference to the attached drawings. In the present embodiment, a recording/reproducing device as an information retrieving device having an information processor of the present invention is exemplified, but the present invention may also be applied to a recorder only for recording information, an independent information processor for recording information on the recorder or the recording/reproducing device, an information processor for controlling receiving (retrieving) information performed by a receiver such as TV which does not have a recording system, and the like. Although, the present embodiment exemplifies a process for retrieving contents data of a TV program (information) based on an EPG (Electric Program Guide) as program information (detail information) of broadcast programs, the arrangement is not limited thereto, and any other arrangements may be employed, where the information can be a broadcasted contents such as radio broadcast programs and satellite broadcast programs, a distributed contents such as music and video, and a contents of various programs such as game software created by an individual and sharable, which are retrieved based on guide information about a guide including a name or a detail of each information. A process for recording information will be referred to as a process for recording contents, while an information processing will be referred to as a process for reproducing the contents.

[Arrangement of Contents Recording/Reproducing System]

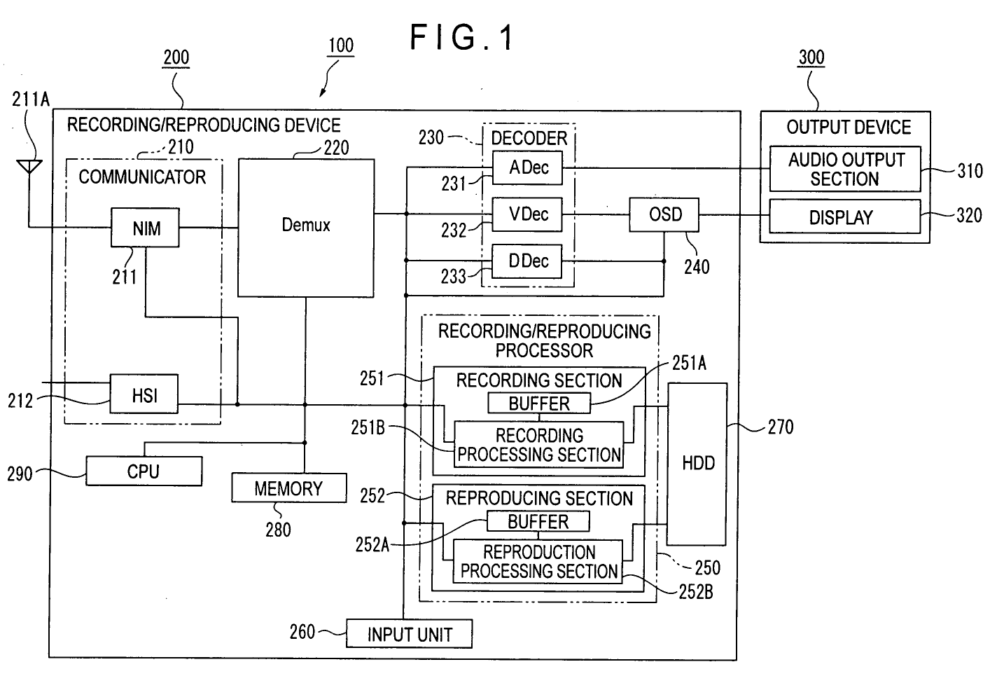

In FIG. 1, a reference numeral 100 is a contents recording/reproducing system (hereinafter referred to as recording/reproducing system) for recoding, for instance, contents data including audio data, video data, data casting data, etc. of a contents (information) such as TV program, and reproducing the recorded contents data. The recording/reproducing system 100 includes a recording/reproducing device 200 as an information recorder and an output device 300 as an information processing unit.

The output device 300 includes, for instance, a personal computer, a television, a mobile phone, a PHS (Personal Handyphone System), a PDA (Personal Digital Assistant), and so on. The output device 300 receives and outputs contents data output from the recording/reproducing device 200. The output device 300 may employ any arrangement such as an arrangement for outputting the audio data as sound, an arrangement for displaying the video data, the broadcast data, the EPG data and the combined data on a screen, and an arrangement, as shown in FIG. 1, including both an audio output section 310 for audio output and a display 320 for screen display.

The recording/reproducing device 200 retrieves and records contents data including audio data, video data, data casting data, etc. distributed as TS (Transport Stream) and outputs the contents data from the output device 300. The recording/reproducing device 200 reproduces the recorded contents data to be output from the output device 300. In addition, the recording/reproducing device 200 automatically deletes the recorded contents data. The recording/reproducing device 200 includes a communicator 210 functioning as an information retriever and a detail information retriever, a demultiplexer (Demultiplexer; Demux) 220, a decoder 230, an on-screen display (On Screen Display; OSD) 240, a recording/reproducing processor 250, an input unit 260, a hard disk (Hard Disk Drive; HDD) 270 as a storage, a memory 280, a CPU (Central Processing Unit) 290 as an information processor being a computing unit, and the like.

The communicator 210 retrieves contents data input from the outside and outputs the retrieved contents data to the outside. The communicator 210 may employ any arrangement such as an arrangement fore receiving broadcast wave of terrestrial digital broadcasting and satellite digital broadcasting, an arrangement for retrieving a TS or a partial TS (described later) that is sent as a digital signal and sending to/from the recording/reproducing device 200, and an arrangement, as shown in FIG. 1, including both a network interface module (Network Interface Module; NIM) 211 having an antenna 211A for receiving broadcast wave and a high speed interface (High speed Interface; HSI) 212 for retrieving and processing a TS and a partial TS.

The Demux 220 retrieves a TS and separates a TS packet from the TS to output the TS packet. The Demux 220 is connected to the decoder 230, the recording/reproducing processor 250, the CPU 290, etc. The Demux 220 retrieves the TSs from the NIM 211 and HSI 212 under the control of the CPU 290. Then, TS packets of various data corresponding to selected contents are retrieved from the TSs. More specifically, the Demux 220 retrieves a TS packet embedding audio data (hereinafter, referred to as audio packet), a TS packet embedding video data (hereinafter, referred to as video packet) and a TS packet embedding data casting data or EPG data (hereinafter, referred to as data packet). The Demux 220 outputs the retrieved audio packet, video packet and data packet to the decoder 230.

In the EPG data, information about the contents such as TV program of each TS that can be retrieved by the NIM 211 is indicated in a text format such as BML (Broadcast Markup Language) and XML (extensible Markup Language). Although described later in detail, the EPG data is constituted as a data structure including a program description regarding a program name, a detail of program, etc., and information such as start time/date, broadcasting time length, channel, genre, series name.

Once the Demux 220 retrieves each of the TS packets corresponding to the selected contents from the retrieved TSs under the control the CPU 290, the Demux 220 restructures each of the TS packets into a set of data array structure, namely, a partial TS. The partial TS is output to the recording/reproducing processor 250. The Demux 220 retrieves the partial TS from the HSI 212 and the recording/reproducing processor 250 under the control of the CPU 290. The Demux 220 then separates the partial TS into the audio packet, the video packet and the data packet to output the separated packets to the decoder 230.

The decoder 230 is connected to the Demux 220, the OSD 240, the CPU 290, the output device 300, etc., the decoder 230 decoding each of the packets retrieved from the Demux 220 to output the packet to the OSD 240 and the output device 300. The decoder 230 may employ any arrangement such as arrangements each for decoding the audio data, the video data, or the data casting data or the EPG data, an arrangement including the above arrangements in combination, and an arrangement, as shown in FIG. 1, including an audio decoder (Audio Decoder; ADec) 231, a video decoder (Video Decoder; VDec) 232 and a data decoder (Data Decoder; DDec) 233 for decoding audio, video and data.

The OSD 240 is connected to the CPU 290 and the display 320 of the output device 300. The OSD 240 retrieves the video data from the VDec 232 and the data casting data or the EPG data from the DDec 233 to produce combined data, in which a video, a caption, a program list, etc. are selectively displayed in a superposing manner or in a side-by-side manner, under the control of the CPU 290. The combined data is sent to the display 320 of the output device 300 to be output therefrom. Incidentally, the OSD 240 may not be included.

The recording/reproducing processor 250 is connected to the HDD 270, the CPU 290, etc. The recording/reproducing processor 250 retrieves the partial TS from the Demux 220 to store it in the HDD 270. The recording/reproducing processor 250 also retrieves the partial TS stored in the HDD 270 and outputs the partial TS to the HSI 212 and the Demux 220. The recording/reproducing processor 250 includes a recording section 251 and a reproducing section 252.

The recording section 251 stores the partial TS retrieved from the Demux 220 in the HDD 270. The recording section 251 includes a buffer 251A, a recording processing section 251B, and the like. The buffer 251A temporarily stores the partial TS retrieved from the Demux 220. The recording processing section 251B retrieves the partial TS from the Demux 220 to readably store it in the buffer 251A under the control of the CPU 290. The recording processing section 251B reads the partial TS stored in the buffer 251A to output the read partial TS to the HDD 270.

The reproducing section 252 outputs the partial TS stored in the HDD 270 to the HSI 212 and the Demux 220. The reproducing section 252 includes a buffer 252A, a reproduction processing section 252B, and the like. The buffer 252A temporarily stores the partial TS retrieved from the HDD 270. The reproduction processing section 252B retrieves the partial TS from the HDD 270 to readably store the partial TS in the buffer 252A under the control of the CPU 290. The reproduction processing section 252B reads out the partial TS stored in the buffer 252A to output the read partial TS to the HSI 212 and the Demux 220.

The input unit 260 is connected to the CPU 290. The input unit 260 includes various operation buttons and operation knobs (each not shown) provided for input operation, for instance, on a front side of a casing (not shown). The input operation performed on the operation buttons and the operation knobs includes, for instance, settings for operations of the recording/reproducing device 200. More specifically, a setting regarding recording and reproducing of the contents, setting of TS received by the NIM 212 (Translator's comment: correctly, NIM 211) and the like can be exemplified The input unit 260 also functions as a generator for generating request information (described later in detail) for requesting execution of recording and reproducing in accordance with the input operation. The input unit 260 sends various information to the CPU 290 as operation signals by the input operation for the settings. Note that the input unit 260 may have a remote control receiver for receiving the various information sent from a remote controller (not shown) via infrared rays and sending the various information to the CPU 290 as the operation signals.

The HDD 270 is connected to the CPU 290. The HDD 270 is controlled by an ATA (AT Attachment) interface. Incidentally, although the HDD 270 is controlled by the ATA interface in the embodiment, the HDD 270 may also be controlled by an IDE (Integrated Drive Electronics) interface, an SCSI (Small Computer System Interface) interface, and the like. Further, an arrangement having a drive or a driver readably storing various information in various recording media including a detachable medium such as an optical disc like a DVD (Digital Versatile Disc), a magnetooptical disc and a memory card as well as a fixed memory, or an arrangement combining a plurality of such drivers and drives may be employed in place of the HDD 270. The HDD 270 readably stores the partial TS of the contents input from the recording section 251, namely, the contents data, the EPG data, etc.

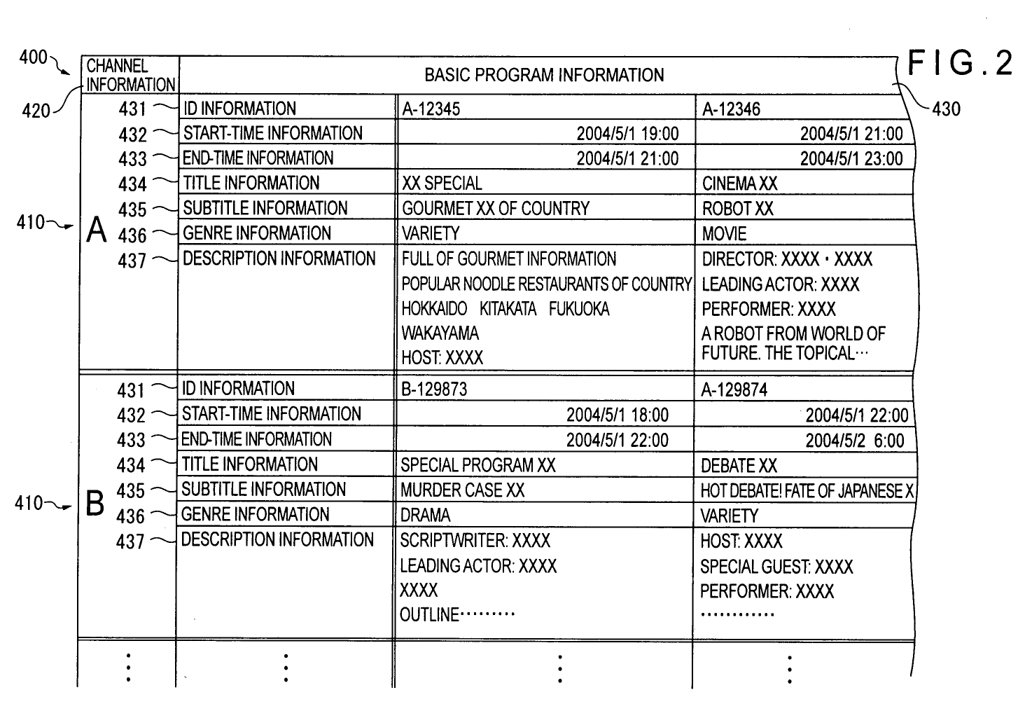

The HDD 270 has a data storage area (not shown) for storing the contents data and an EPG storage area (not shown) for storing the EPG data as a program information table 400 as shown in FIG. 2. Although described later in detail, the HDD 270 also includes a storage area for storing a word information table for extracting the related keyword information from the keyword information for computing priority.

The program information table 400 is generated based on an EPG described in the EPG data output from the OSD 240. The EPG included in broadcast wave transmitted from each broadcast station is program information mainly including TV programs that are scheduled to be broadcasted by the broadcast station. The program information table 400 has a table structure including the EPG of each broadcast station in combination, which is stored in the EPG storage area. The EPG storage area storing the program information table 400 has a table structure for storing plural sets of program information 410 as detail information constituted as a data structure in which, for instance, channel information 420 about a broadcast channel of a TV program, basic program information 430, etc. are mutually associated.

The channel information 420 is information about a channel on which a TV program is broadcasted. The channel information 420 is set individually for each area where the TV program is broadcasted.

In the basic program information 430 detailed information such as broadcasting time and details of the TV program is recorded. The basic program information 430 includes ID information 431 as unique specifying information assigned to each basic program information 430, start-time information 432, end-time information 433, title information 434, subtitle information 435, genre information 436, description information 437 and the like, the basic program information 430 being constituted as a data structure. The various information included in the basic program information 430 has a simple structure using a text format (character string). Incidentally, the program ID information 431 may not be included because the program can be specified by the channel information and the start-time information

The start-time information 432 is related to a scheduled start time of broadcasting of a TV program. The start-time information 432 includes a date and time for starting broadcasting of the TV program. The start-time information 432 is referred to in generating a timer-recording information list (described later) and in performing a process for starting recording of the TV program in the recording section 251 of the recording/reproducing processor 250.

The end-time information 433 is related to a scheduled termination time of a TV program. The end-time information 433 includes a date and time for terminating broadcasting of the TV program. The end-time information 433 is referred to in performing a process for terminating recording of the TV program in the recording section 251 of the recording/reproducing processor 250

The title information 434 is related to a name such as program name and title of a TV program. The subtitle information 435 is related to subtitle of a TV program.

The genre information 436 describes which genre a TV program belongs to, when the TV program is categorized by details thereof. For instance, “variety”, “drama”, “movie”, “press report”, “news”, “sport” can be exemplified as the genre. Further, as the genre information 436, for instance, information categorized into sub-genres such as “song” and “entertainment” may be associated with the “variety”.

The description information 437 is information in which details of a TV program, e.g., a simple description about a broadcasting detail of the TV program, an outline of the program from the previous broadcast, and a personal name such as a performer, a director and a scriptwriter of the TV program are described in the text format.

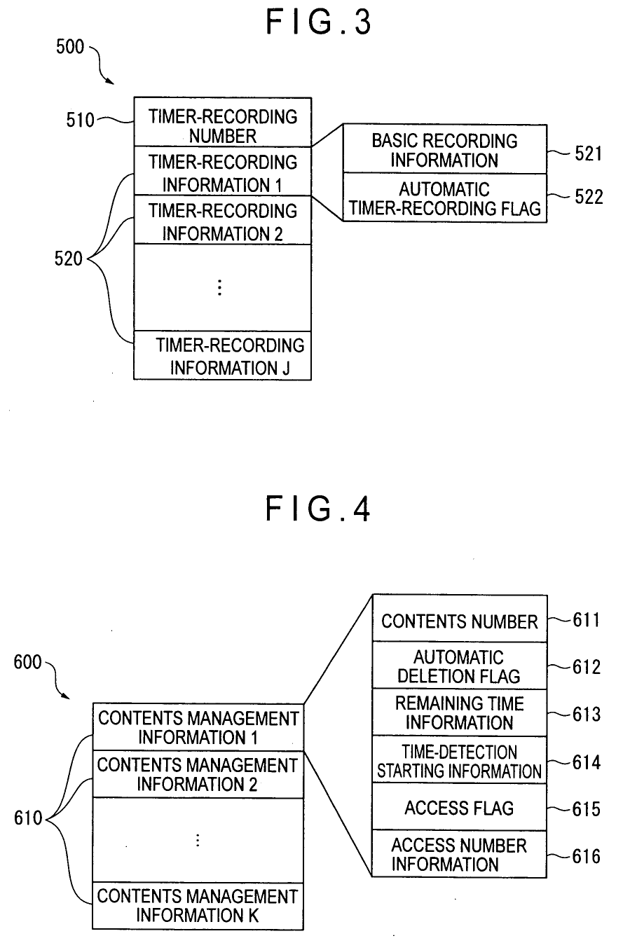

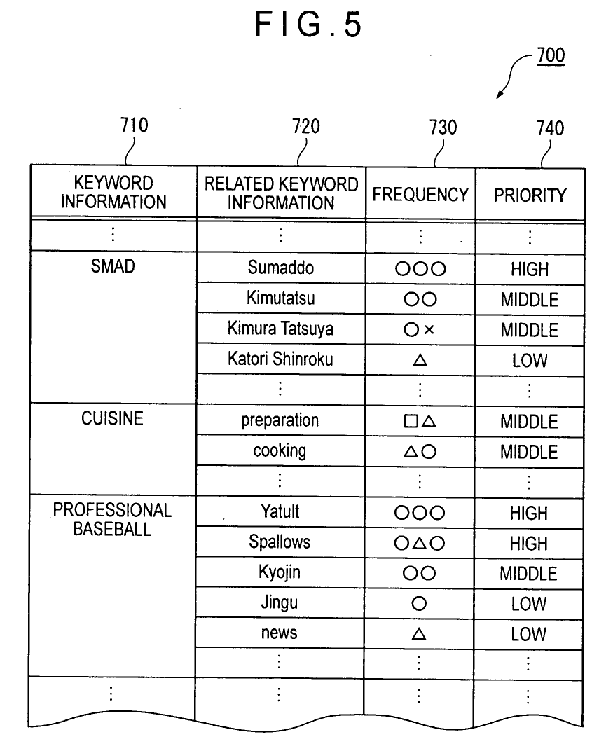

The memory 280 readably stores various data required in retrieving desired contents data from the TS output from the NIM 211 for recording and in reproducing the recorded contents data. The memory 280 readably stores, for instance, a timer-recording list 500 (FIG. 3), a contents management list 600 (FIG. 4) and keyword history information 700 (FIG. 5).

The timer-recording list 500 is related to a list of a manual timer-recording and an automatic timer-recording. The timer-recording list 500 is constituted as a data structure in which, for instance, timer-recording number 510 and at least one of timer-recording information 520 are mutually associated.

The timer-recording number 510 is related to the total number of the timer-recording information 520. The timer-recording number 510 is added by one when the manual timer-recording or the automatic timer-recording is set by the CPU 290, and reduced by one when recording based on the set manual timer-recording or the set automatic timer-recording is terminated.

The timer-recording information 520 is related to the manual timer-recording or the automatic timer-recording. The timer-recording information 520, by the CPU 290, is added to the timer-recording list 500 when the manual timer-recording or the automatic timer-recording is set, and deleted from the timer-recording list 500 when the recording based on the manual timer-recording or the automatic timer-recording is terminated. The timer-recording information 520 is constituted as a data structure in which basic recording information 521, automatic timer-recording flag 522, etc. are mutually associated.

The basic recording information 521 is various information used for executing a manual timer-recording process and an automatic timer-recording process. The basic recording information 521 is constituted as a data structure in which recording start time/date, recording termination time/date, channel, etc. are mutually associated. The basic recording information 521 is appropriately changed by the CPU 290.

The automatic timer-recording flag 522 is flag information indicating whether a recording process based on the basic recording information 521 is the automatic timer-recording process or not. For instance, the automatic timer-recording flag 522 being “0” indicates the manual timer-recording process (not the automatic timer-recording process) and “1” indicates the automatic timer-recording process.

The contents management list 600 is related to a list of information corresponding to the contents recorded in the HDD 270. The contents management list 600 is constituted as a data structure with which at least one of the contents management information 610 is associated.

The contents management information 610 is, by the CPU 290, added to the contents management list 600 when a contents is recorded in the HDD 270, and deleted from the contents management list 600 when the contents is deleted from the HDD 270. The contents management information 610 is constituted as a data structure in which a contents number 611, an automatic deletion flag 612 as data attribute information, remaining time information 613, a time-detection starting information 614, an access flag 615 as processing status information, access number information 616 as detail frequency information of the processing status information and the like are mutually associated. The contents management information 610 is associated with, for instance, the basic program information 430 corresponding to the contents and the ID information 431 associated with the basic program information 430. In other words, a detail of the contents data recorded in the HDD 270 can be checked through the contents management information 610.

The contents number 611 is related to number specifically assigned to the contents recorded in the HDD 270. Note that information such as name specifically assigned to the contents may be used instead of the contents number 611.

The automatic deletion flag 612 is flag information indicating whether or not a contents specified by the contents number 611 is targeted to be automatically deleted by the CPU 290. For instance, the automatic deletion flag 612 being “0” indicates that the contents is not targeted to be automatically deleted, and “1” indicates that the contents is targeted to be automatically deleted. The automatic deletion flag 612 is appropriately reset by the CPU 290.

The remaining time information 613 is related to remaining time until the contents specified by the contents number 611 is automatically deleted. The remaining time information 613 is appropriately reset by the CPU 290.

The time-detection starting information 614 is related to time-detecting start date/time indicating a date/time for staring time detection of a period T that has been set in advance. The time-detecting start date/time is a date/time of termination of recording as a data storing date/time of the contents specified by the contents number 611, or a date/time when the remaining time information 613 is changed by the CPU 290. The time-detection starting information 614 is appropriately changed by the CPU 290.

The access flag 615 is flag information indicating whether a process for recording or editing the contents specified by the contents number 611 has been executed at least once or not, in other words, whether the contents has been accessed at least once or not. Specifically, the access flag 615 being “0” indicates that the accessing has never been performed, while “1” indicates that the accessing has been performed at least once. The access flag 615 is appropriately changed by the CPU 290.

The access number information 616 is related to the number of accessing times to the contents specified by the contents number 611. The access number information 616 is appropriately changed by the CPU 290.

The keyword history information 700 is based on a recording history, a viewing history or a reproducing history of contents data having been recorded, viewed or reproduced in the past. As shown in FIG. 5, the keyword history information 700 is constituted as a data structure in which pluralities of keyword information 710, related keyword information 720, frequency information 730, priority information 740, etc. are mutually associated.

The keyword information 710 is related to a keyword corresponding to a detail as a character string indicating the genre and the keyword for specifying a TV program, which is input on the input unit 260 for performing recording, viewing or reproducing of the TV program. The keyword information 710 may include a keyword having been stored and set in the memory 280, a keyword input by the user or retrieved through the network, a keyword extracted from the program information 410 by, for instance, morphological analysis and a keyword having been input in the past for requesting recording, viewing or reproducing.

The related keyword information 720 is a character string of a related keyword related to a keyword. The related keyword may include a synonym, an appellation, an abbreviation, a formal name, an associated phrase, a phrase indicating related area, place, building and climate, and the like. For instance, related keywords for “SMAD” (Translator's comment: as a group of people), may include “Sumaddo” (Translator's comment: Japanese pronunciation for “SAMAD”) as the appellation, “Kimura Tatsuya” and “Katori Shinroku” each as a member, “Kimutatsu” as the associated phrase for “Kimura Tatsuya” as a representative member, “SMADXSMAD” as a name of a program of which “SMAD” appears and “variety” as a genre of the program. Related keywords for “professional baseball” may include, for instance, “Yatult”, “Spallows” and “Kyojin”, etc. as teams playing a game, the appellations, the abbreviations or the formal names thereof, “Jingu” and “Keihin Dome” as stadiums of the game, and “news” as a genre or an associated phrase. The related keyword information 720, as with the keyword information 710, may include a keyword having been stored and set in the memory 280, a keyword input by the user or retrieved through the network, and a phrase extracted from the program information 410 including keywords by, for instance, morphological analysis. A phrase extracted from the program information 410 corresponding to the program recorded, viewed or reproduced in the past can also be exemplified. For the associated phrase, a phrase related to a keyword in questionnaires can be exemplified. Any phrase associated with the keyword can be employed.

The frequency information 730 is related to an appearance frequency as a frequency with which related keyword information 720 appears in program information 410, the frequency information 730 being associated with the corresponding related keyword information 720. The frequency information 730 is an appearance frequency of related keyword information in program information 410 corresponding to processed contents data, based on a history of processes for recording, viewing or reproducing contents data of each TV program performed by the user in the past. Specifically, the frequency information 730 is a frequency of a related keyword appearing in program information 410 including a keyword input by the user for requesting the process, in other words, information about a number or number of times the related keyword appears in combination with the keyword, which is computed (counted) by processing of the CPU 290. Incidentally, the frequency information 730 does not have to be computed based on all of the recording history, the viewing history and the reproducing history, but may be computed based on any of them or any combination of them. The frequency information is not limited to the appearance frequency of the related keyword in combination with the keyword, but may be an appearance frequency solely for the related keyword.

The priority information 740 is related to priority of the related keyword information 720 based on the frequency information 730, the priority information 740 being associated with the corresponding related keyword information 720. Specifically, the priority is set, for instance, in three steps of “high”, “middle” and “low” in descending order of the appearance frequency of the corresponding related keyword by computation of the CPU 290, in other words, the priority is set by the CPU 290 based on threshold having been set in advance. Incidentally, without limiting to the three steps, the priority may be a value of the appearance frequency or may be set by scoring (weighting) based on the value of the appearance frequency. In addition to the arrangement for generating the priority by computation, the priority of the related keyword may be set in advance based on, for instance, questionnaires, may be set by the user, or may be retrieved through the network.

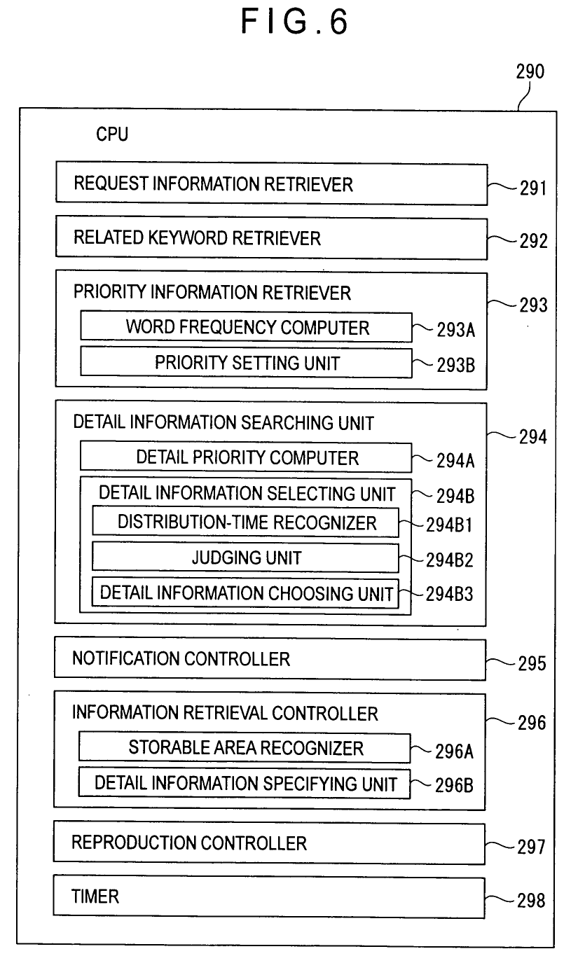

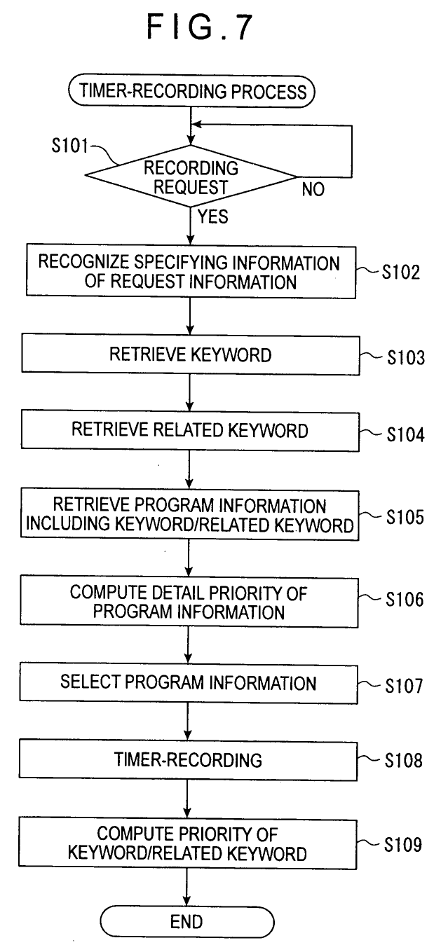

The CPU 290 is connected to various components to control operations of those components. As shown in FIG. 5 (Translator's comment, correctly, FIG. 6), the CPU 290 includes, as various programs, a request information retriever 291, a related keyword retriever 292, a priority information retriever 293, a detail information searching unit 294, a notification controller 295, an information retrieval controller 296, a reproduction controller 297 and a timer 298 and the like.

The request information retriever 291 retrieves request information input by a predetermined input operation on the input unit 260. The request information is related to a request for receiving and retrieving by the communicator 210 contents data corresponding to a genre or a keyword of a predetermined detail for recording or outputting (viewing or reproducing), and a request for deleting contents data stored in the HDD 270 In other words, the request information includes specifying information (not shown) such as genre and keyword for specifying a TV program and contents data. The request information retriever 291 recognizes whether the manual recording is requested or the automatic recording is requested based on the specifying information. Specifically, the request information retriever 291 recognizes whether the automatic recording is requested based on the genre or the keyword, or the manual recording is requested where a TV program is specified and the contents data of the specified TV program is recorded. Incidentally, the request information retriever 291 may directly include information indicating manual recording or automatic recording.

The related keyword retriever 292 retrieves the related keyword information 720 for a related keyword related to the keyword of the keyword information 710 included in the specifying information of the request information retrieved by the request information retriever 291. The related keyword retriever 292 searches and retrieves the related keyword information 720 associated with the keyword information 710 of the specifying information, based on the keyword history information 700. The retrieved related keyword information 720 is stored in the memory 280. The related keyword retriever 292 reads the program information 410 including the keyword of the keyword information 710 from the program information table 400, extracts the keyword included in the program information 410 by, for instance, morphological analysis to generate the related keyword information 720, and associates the generated related keyword information 720 with the keyword information 710 to record (list) it in the keyword history information 700. Without limiting to an arrangement for extracting the related keyword from the program information 410 including the keyword information 710, the related keyword retriever 292 may also employ an arrangement where, for instance, program information 410 including a keyword and a related keyword read from the keyword history information 700 is read, a keyword is extracted from the program information 410, and the extracted keyword is listed in the keyword history information 700 as a related keyword. When the number of related keywords to be retrieved, which has been set in advance, or the number of retrievals described in the specifying information is limited by the user's input, the related keyword retriever 292 may narrow the retrieval, in other words, may retrieve the related keyword information 720 in descending order of the priority, based on the priority associated with the related keyword information 720 in the keyword history information 700. Alternatively, using the notification controller 295 (described later), retrieved related keywords are listed and displayed as a list on the display 320, so that the related keyword information 720 may be selected by an input operation on the input unit 260. When the narrowing is required with the greatest limitation, the related keyword is limited to the one same as the keyword, in other words, the related keyword information 720 to be retrieved becomes zero, so that the program information 410 only including the keyword is searched by the detail information searching unit 294.

The priority information retriever 293 retrieves the priority information about the priority of the related keyword in the related keyword information 720 retrieved by the related keyword retriever 292. Specifically, the priority information retriever 293 retrieves the priority information 740 associated with the related keyword information 720 based on the keyword history information 700. The priority information retriever 293 computes the priority of the related keyword information 720 to generate the priority information, and associates the priority information with the related keyword information 720 to record (list) it in the keyword history information 700. The priority information retriever 293 includes a word frequency computer 293A, a priority setting unit 293B also functioning as a priority adjuster, etc.

The word frequency computer 293A computes, when the related keyword retriever 292 extracts the related keyword information 720 from the program information 410, the frequency information about the appearance frequency of the related keyword. The word frequency computer 293A computes the appearance frequency of a combination of the keyword and the related keyword based on the processing history such as recording history, viewing history and reproducing history of the contents data. Specifically, when the related keyword information 720 extracted by the related keyword retriever 292 is associated with the keyword information 710 to record in the keyword history information 700, if the combination of the keyword information 710 and the related keyword information 720 has been already recorded, the word frequency computer 293A increases the frequency of the frequency information 730 by adding, for instance, “1”, and if not recorded, the word frequency computer 293A computes and sets the frequency to, for instance, “1” in associating the keyword information 710 and the related keyword information 720 to record. The computing method is not limited to the above described method.

The priority setting unit 293B sets the priority based on the frequency information 730. As described above, the priority setting unit 293B sets the priority in accordance with the value of the frequency information 730 based on threshold having been set in advance for the three steps of “high”, “middle” and “low” in such a manner that the priority is set in descending order of the appearance frequency of the combination of the keyword and the related keyword in the frequency information 730. The set priority is appropriately recorded (updated) in the keyword history information 700. Incidentally, the priority may be so set that, when updating frequency of the frequency information 730 is determined to be high, score of the priority may be increased specially, so that the priority easily becomes relatively high. On the other hand, when the frequency of the combination of the keyword and the related keyword is not updated for a predetermined period of time (e.g. for several years), the priority setting unit 293B may lower the set priority. For instance, based on the current time being detected and information about the last computing date/time (not shown) associated with the frequency information 730, updating status at the current time being detected is judged, and if it is judged that the frequency is not updated for a predetermined period of time, setting of the priority is changed. Although described later in detail, when the contents data having been stored is deleted from the HDD 270, the priority may be lowered based on the program information 410 corresponding to the contents data or by recognizing the combination of the keyword and the related keyword used for retrieving the contents data. The computing method is not limited to the above described method. Although the priority is obtained based on the keyword history information 700 in the above description, the priority may be computed without using the keyword history information 700, in other words, not based on the history. In such arrangement, the priority may be obtained by extracting the related keyword from the program information 410 extracted based on the keyword of the request information and by computing the priority using the appearance frequency of the related keyword for every request from the user. The detail information searching unit 294 searches, based on the priority information 740 retrieved by the priority information retriever 293, the program information 410 including the keyword of the keyword information 710 included in the request information retrieved by the request information retriever 291 and the related keyword of the related keyword information 720 retrieved by the related keyword retriever 292, in accordance with the priority. The detail information searching unit 294 includes a detail priority computer 294A, a detail information selecting unit 294B, etc.

The detail priority computer 294A searches the program information 410 including the keyword and the related keyword and computes the priority of each of the detected program information 410 based on the priority information to compute detail priority information. For the computation, keywords included in the program information 410 are extracted to create combinations of the extracted keywords. The combination of the keyword and the related keyword same as the created combination of the keywords is searched from the keyword history information 700, and the frequency information 730 or the priority information 740 associated with the detected combination of the keyword and the related keyword is read. The detail priority is obtained from a score value which is obtained by multiplying the average of the values of each of the read frequency information 730 or the priorities of the read priority information 740 and value of the frequency information 730 or priority of the priority information 740 associated with the priority of the combination of the keyword and the related keyword in searching the program information 410. Any computing method may be employed in which, for instance, the detail priority is obtained by setting several steps based on threshold having been set in advance in the same manner as the priority, or the priority of the combination of the keyword and the related keyword used in searching the program information 410 is simply employed as the detail priority without computing the average of the frequency information 730.

The detail information selecting unit 294B selects the program information 410, in other words, performs narrowing process, based on the detail priority information of each of the program information 410 obtained by computation by the detail priority computer 294A. For instance, in descending order of the score value of the detail priority information, a preset number of the program information 410 are selected. The selecting number may also be one. The detail information selecting unit 294B further selects the program information 410 depending on distribution-time information about time for distribution of the selected program information 410, based on the detail priority information. The detail information selecting unit 294B includes a distribution-time recognizer 294B1, a judging unit 294B2, a detail information choosing unit 294B3 and the like.

The distribution-time recognizer 294B1 reads the distribution-time information of the selected program information 410, in other words, the start-time information 432 and the end-time information 433 as information about broadcasting time. The judging unit 294B2 judges an overlapping state of time slots (overlap state) of the selected program information 410 to select the program information 410 of which the broadcast time are overlapped, based on the start-time information 432 and the end-time information 433 of each of the read program information 410. The detail information choosing unit 294B3 recognizes the detail priority information of the program information 410 selected by the judging unit 294B2 and chooses the program information with higher priority.

As described above, the detail information selecting unit 294B selects the program information 410 whose broadcast time does not overlap with that of others. The detail information searching unit 294 may employ any method in selecting the program information 410 based on the priority; the detail information searching unit 294 may list the program information 410 by recognizing the overlap state of the broadcast times and performing narrowing process in advance to select the program information 410 based on the detail priority information, or by selecting preferentially the program information 410 including the related keyword with high priority in selecting overlapping program information 410 without computing detail priority information. The detail information searching unit 294 may select the program information 410 including the keyword and the related keyword only for computing the detail priority information to be associated therewith. Although, the program information 410 to be searched includes both keyword and related keyword in the above description, the program information 410 to be searched may include at least one of them.

The notification controller 295 displays a list of the program information 410 detected by the detail information searching unit 294 on the display 320 of the output device 300 in a manner selectable by the input unit 260. Specifically, the notification controller 295 generates display window information for displaying the list of the program information 410 and controls the OSD 240 to display the display window information on the display 320. The displayed list includes, for instance, information such as broadcast time and program title. Incidentally, keywords and related keywords as detecting parameter may be listed, priorities and the detail priorities may be listed, or titles in the displayed list may be displayed in different ways such as differences in color, brightness and blinking in accordance with the detail priority. When recognizing that predetermined program information 410 is selected by the input operation on the input unit 260, the notification controller 295 outputs a predetermined signal to the information retrieval controller 296 so that the selected program information 410 can be specified by the information retrieval controller 296.

The information retrieval controller 296 receives TV programs corresponding to the program information 410 detected by the detail information searching unit 294 to recordably or viewably process the TV programs. In other words, the timer-recording information 520 is generated based on the program information 410. When the notification controller 295 recognizes that the predetermined program information 410 is selected, the information retrieval controller 296 generates the timer-recording information 520 based on that program information 410. Note that the detail priority information of the corresponding program information 410 is associated with the timer-recording information 520. In generating the timer-recording information 520, the information retrieval controller 296 specifies the predetermined program information 410 in accordance with a preset number, a setting of the number for automatic timer-recording in the specifying information or free area of the HDD 270, based on the detail priority information, in other words, the information retrieval controller 296 performs further narrowing process. The information retrieval controller 296 includes a storable area recognizer 296A, a detail information specifying unit 296B, and the like.

The storable area recognizer 296A recognizes the size of a free space (free area), which is a storable area in the data storage area (not shown) as a storage area for storing the contents information of the HDD 270. The detail information specifying unit 296B recognizes the size of the contents data to be recorded based on the detected program information 410. The detail information specifying unit 296B specifies the program information 410 based on the detail priority information in accordance with the size of the free area recognized by the storable area recognizer 296A. More specifically, when a predetermined free area can be secured even if the contents data of all of the program information 410 are stored in the HDD 270, all of the program information 410 are specified. On the other hand, when enough free area cannot be secured, only the program information 410 having higher detail priority is specified. The predetermined free area is a space in which several programs can be stored in accordance with, for instance, a request of manual-recording. The program information 410 having higher detail priority may be specified until a predetermined free area is consumed in descending order of the detail priority, or may be specified based on status of manual timer-recording request and status of manual timer-recording that has been already set.

The information retrieval controller 296 narrows a plurality of the detected program information 410 into a preset number or an input number in descending order of the detail priority. Incidentally, the narrowing process may be performed based on one of the number or the free area, or based on both, or the narrowing process may not be performed. The information retrieval controller 296 generates the timer-recording information 520 based on the program information 410 specified as described above.

The information retrieval controller 296 controls operations of the NIM 211, Demux 220 and the recording section 251 of the recording/reproducing processor 250 to receive contents data of the desired TV program and readably store it in the HDD 270, based on the generated timer-recording information 520. Specifically, the information retrieval controller 296 stores the contents data currently being received and reproduced according to an operation signal based on input operation on the input unit 260, or receives and stores such contents data that the recording start time of the basic recording information 521 in the timer-recording information 520 overlaps with current time being detected by the timer 298 (described later) based on the timer-recording list 500. The detail priority information is associated with the recorded contents data.

When, for instance, a plurality of manual timer-recording requests are set and the free area cannot be secured sufficiently and becomes smaller, based on the free area of the HDD 270 recognized by the storable area recognizer 296A, the information retrieval controller 296 may perform processing such that timer-recording information 520 having low priority of the detail priority information associated therewith is deleted or provided with flag information indicating that the recording is not performed until the free area is restored. As the free area becomes smaller, the information retrieval controller 296, based on the detail priority information associated with contents data having been stored, automatically may delete the contents data with low priority to secure the free area. Such processes for deleting or providing the flag information to the timer-recording information 520 or deleting the contents data are targeted to the timer-recording information or the contents data corresponding to the automatic timer-recording request based on the keyword. Thus, the manual timer-recording or the contents data that is directly set by the user and greatly reflects the user's preference can be secured, so that proper recording of the contents data can be obtained.

The reproduction controller 297 controls operations of the Demux 220, the decoder 230 and the reproducing section 252 of the recording/reproducing processor 250 to output the desired contents data to the output device 300 for reproduction. Specifically, the reproduction controller 297 reads out from the HDD 270 the contents data specified by the operation signal based on the input operation on the input unit 260, e.g., the contents data specified by the input operation for selecting a thumbnail displayed as a list on the output device 300, or the contents data that has been requested in advance for reproduction at a predetermined time (timer reproducing), to appropriately process the contents data in the decoder 230 and output the decoded contents data to the output device 300.

The timer 298 detects the current time based on a standard pulse of an internal clock or the like to generate current time information.

[Operation of Contents Recording/Reproducing System]

Next, a process for setting the priority in the operation of the recording/reproducing system 100 will be described with reference to the attached drawings. Note that although a process for computing priority by simultaneous processing in computation of recording request will be described, the arrangement is not limited thereto.

The CPU 290 of the recording/reproducing device 200 judges, at the request information retriever 291, whether recording request information as request information for retrieving (recording) contents data of a predetermined TV program is input or not by an input operation of a user on the input unit 260 (step S101). In other words, the CPU 290 is in standby state for input of the request information. Then, when the request information retriever 291 retrieves the recording request information, the request information retriever 291 recognizes specifying information of the recording request information (step S102), and extracts keyword information 710 from the specifying information (step S103).

After the step S103, the CPU 290 retrieves related keyword information 720 related to the keyword information 710 retrieved in the step S103 by the related keyword retriever 292 (step S104). In other words, the related keyword retriever 292 reads related keyword information 720 related to the keyword information 710 retrieved in the step S103, based on the keyword history information 700. Then, the CPU 290 searches by the detail information searching unit 294 program information 410 including the keyword information 710 and the related keyword information 720 from the program information table 400 (step S105).

The detail information searching unit 294 searches the program information 410 including the keyword information 710 and the related keyword information 720 by the detail priority computer 294A, extracts keywords from the detected program information 410 to combine the keywords, and reads frequency information 730 or priority information 740 of a combination of a keyword and a related keyword same as the combined keywords. Then, based on the frequency information 730 or the priority information 740, detail priority as priority of each of the detected program information 410 is computed (step S106). The detail information selecting unit 294B then selects a preset number of the program information 410 in descending order of the detail priority, based on the computed detail priority information (step S107).

Based on the program information 410 detected and selected in the step S107, the information retrieval controller 296 generates the timer-recording information 520 (step S108). Then, the information retrieval controller 296 receives a TV program in accordance with the timer-recording information 520, while monitoring the free area of the HDD 270 by the storable area recognizer 296A, and retrieves the contents data to be stored in the HDD 270.

The CPU 290 computes the priority of the related keyword of the program information 410 detected and selected in the step S107 (step S109). In other words, a keyword is extracted by the related keyword retriever 292 using morphological analysis or the like. The CPU 290 generates the extracted keywords as related keyword information 720 related to the keyword of the keyword information 710 retrieved from the specifying information of the request information, and lists the related keyword information 720 in the keyword history information 700. In listing the related keyword information 720, the word frequency computer 293A of the priority information retriever 293 computes appearance frequency of the combination of the keyword and the related keyword and updates the frequency information 730. Further, the priority setting unit 293B of the priority information retriever 293 computes the priority based on the frequency information 730 to update the priority information 740, and the process is terminated.

[Advantage of Contents Recording/Reproducing System]

As described above, in the above embodiment, when request information such as recording request information for receiving through the communicator 210 contents data of a TV program of a predetermined detail is retrieved by the request information retriever 291, related keyword information 720 of a related keyword related to the keyword of the keyword information 710 included in the request information is retrieved from the keyword history information 700. Then, the program information 410 is searched in accordance with the priority information 740 associated with the related keyword information 720 out of the program information 410 including the keyword and the related keyword, and the contents data is received based on the detected program information 410. Thus, since the priority is set for the related keyword related to the keyword for preventing incomplete receiving, the detail can be detected depending on the priority of the related keyword in relation to the keyword, which can prevent the program information 410 from being improperly searched. Thus, the arrangement described above can prevent disadvantages in which, even by using the related keyword related to the keyword, a detail of the program information 410 searched by the related keyword has low correlation with the keyword, the number of the detected program information 410 becomes too large including the ones not expected by the user, and receiving process from the large number of program information 410 becomes bothersome, resulting in lowering processing efficiency, unnecessary consumption of the storage area of the HDD 270, and bothersome operation in selecting desired contents data from the recorded contents data. Therefore, the contents data can be retrieved properly based on the properly detected program information 410. Especially, the above embodiment is useful in retrieving the desired contents data based on the keyword and the related keyword in the arrangement for retrieving the contents data of the TV program using the EPG data.

The related keyword information 720 related to the keyword information 710 is retrieved based on the keyword history information 700 having a table structure, which records a plurality of related keyword information 720 associated with the keyword information 710 as a data structure. Thus, the related keyword information 720 can be retrieved quickly and easily from a simple table structure. By computing an appearance frequency of a combination of the keyword and the related keyword and obtaining the history, the keyword history information 700 of the combination of the keyword and the related keyword can be used for computing the priority Thus, the data structure for properly retrieving the program information 410 can be simplified for retrieving the contents data properly, thus simplifying the arrangement with ease. The priority information computed from the frequency information 730 obtained by computation of the appearance frequency as a history is associated in the keyword history information 700 and constituted as one table structure easily, so that the arrangement can further be simplified. In addition, the priority can be computed in advance, or a set priority can be easily read from the keyword history information 700, thus easily enhancing processing speed.

Also, the keyword extracted from the program information 410 including keywords is extracted as the related keyword. Thus, the related keyword having relatively high correlation with the keyword can be easily obtained. In addition to extracting the related keyword from the program information 410 including keywords, the appearance frequency is computed from the history of a combination of the related keyword and the keyword. Consequently, since the related keyword whose correlation with the keyword is reflected as priority can be obtained, the program information 410 can be selected properly with related keywords as searching target. Therefore, the contents data can be retrieved properly. Further, the priority is computed based on the frequency information 730 obtained by computing the appearance frequency as history. Thus, the priority can be computed easily, so that enhancement of the processing efficiency or formation of the data structure can be easily achieved, and the priority can be easily obtained with simple computation. The combination of the keyword and the related keyword is extracted from the program information 410 corresponding to the timer-recording information 520 to be listed in the timer-recording list, and is reflected to the priority. Thus, the priority can be easily obtained for appropriately selecting the program information 410 to retrieve the contents data desired by the user.

The program information 410 including the keyword and the related keyword read from the keyword history information 700 is read to extract the keyword from the program information 410, and the extracted keyword is listed in the keyword history information 700 as a related keyword. Thus, the related keyword can be prevented from being improperly associated with the keyword, and the priority suitable for the user's preference can be obtained based on the frequency information 730, so that the contents information can be retrieved appropriately. Further, the priority is computed based on the appearance frequency of the combination of the keyword and the related keyword. Thus, in addition to obtaining the priority based on the related keyword, the appearance frequency of the combination is computed, which can prevent a disadvantage in which, for instance, the same priority is set for common related keywords being associated with different keywords, so that the priority of the related keyword can be appropriately obtained.

In a case where the frequency information 730 is not updated for a predetermined period of time, the priority can be lowered. Thus, by lowering the priority, the program information 410 can be selected for retrieving the contents data with a detail more suitable for the current user's preference which is different from that in the past. In a case where the contents data is deleted from the HDD 270, the priority may be lowered. Accordingly, when the contents data retrieved with relatively high detail priority is manually deleted by the user, or when the contents data automatically recorded is deleted, the contents data can be judged to be unsuitable for the user's preference and unnecessary, so that the detail priority can be obtained more appropriately, and thus the contents data can be retrieved more appropriately.

The detail priority of the detected program information 410 is computed based on the priority of the related keyword, and the program information 410 is selected based on the detail priority. With the arrangement, in addition to the more proper retrieval of the program information 410, more proper retrieval and management of the contents data can be realized, where, for instance, the number of contents data received in accordance with the free area of the HDD 270 can further be narrowed, and the contents data having been stored in the HDD 270 can be deleted.

In searching the program information 410, TV programs with overlapping broadcasting times in the recognized broadcast time are selected based on the detail priorities obtained from the priority. Thus, the program information 410 can be appropriately detected for retrieving the contents data more appropriately.

The detected program information 410 is displayed as a list on the display 320 in a manner checkable and selectable by the user, so that the selected program information 410 can further be narrowed. Therefore, proper program information 410 can be retrieved for retrieving the contents data of the TV program desired by the user.

### Modification of Embodiment

The present invention is not limited to the above specific embodiment, but includes modifications as long as the objects of the present invention can be achieved.

As described above, although a system arrangement where the output device 300 for outputting the contents data is connected to the recording/reproducing device 200 having the information processor is exemplified, a recorder only for recording information, an arrangement having an independent information processor for recording information on a recorder or a recording/reproducing device, or an information processor not including a recording unit and controlling a receiver such as television to receive (retrieve) information may also be employed.

Information to be retrieved may include a radio program, a satellite broadcast program, distributed contents such as music and video, various programs such as game software and the like in addition to the TV program. It should be noted that, in retrieving other information, the information should be retrieved based on detail information about a detail of the information; for instance, in a case with application software, the related keyword should be retrieved based on detail information disclosing the detail for downloading and storing the software.

In the above description, the related keyword related to the keyword is read, the program information 410 including the keyword and the related keyword is searched to compute the detail priority of the program information 410, and then the related keyword is extracted from the searched program information 410 for computing the priority. However, in a case where the priority has been set in advance, an order of the computation of the priority and computation of the detail priority information may be reversed; after computing the priority by retrieving the keyword and extracting the related keyword from the program information 410 including the keyword, the program information 410 may be searched to compute the detail priority; or after extracting the related keyword from the program information 410 extracted with the keyword and the related keyword for computing the priority, the detail priority may be computed.

By computing the detail priority information first, the timer-recording information 520 can be generated quickly and properly, and proper contents information can be retrieved quickly. On the other hand, by computing or updating the priority first and then computing the detail priority information, the contents information more suitable for the user's preference may be retrieved.

As history, the related keyword may be extracted from the program information 410 including the keyword. With such arrangement, the related keyword can be associated with the keyword in wide range, so that incomplete searching in searching the program information 410 based on the keyword and the related keyword can be prevented.

Any method may be employed in extracting the related keyword, where for instance, the related keyword may be extracted from the program information 410 including the keyword and the related keyword for searching the program information 410 by the detail information searching unit 294, extracted from the program information 410 specified by the above-described information retrieval controller for generating the timer-recording information 520, or extracted from the program information 410 including the keyword.₀ Incidentally, as described above, by extracting the program information 410 based on the program information 410 obtained by searching, selecting and specifying, the program information 410 does not have to be separately searched, thereby easily enhancing processing efficiency and speed and simplifying the arrangement. On the other hand, in an arrangement for separately searching the program information 410, computation of the priority or the detail priority and generation of the timer-recording information 520 can be performed simultaneously, so that searching efficiency can be enhanced due to parallel processing.

As the priority of the related keyword related to the keyword, although the priority is computed in relation to the keyword in recording request and the detail priority of the program is computed based on the priority in the above description, the priority may be computed, for instance, by extracting keywords from the program information 410 corresponding to reproduced contents data and computing the frequency information 730 by combining the keywords each being related keywords related to each other for computing the priority, in a manner similar to the computation of the detail priority computer 294A. The priority may be computed based on the program information 410 of a TV program as a target of not only recording request but also viewing request. With the arrangement, as with the case of viewing request, since the priority of the related keyword based on the contents data to which the user's preference is directly reflected can be obtained, the contents data more suitable for the user's preference can be retrieved.

For extracting the related keyword, any method can be applied such as a retrieving method, for instance, based on identity of character strings, without limiting to the retrieving method using morphological analysis.

In the above description, although the appearance frequency is computed as the history for each of the recording request, viewing request and reproducing request, the frequency may be computed for one of them or for any combination of them. Especially, as described above, by computing the frequency based on the viewing request and the reproducing request directly related to the user's preference, the information properly meeting the user's preference can be acquired.

Although various functions described above are arranged as programs, any arrangement may be employed including, for instance, hardware such as circuit board or an element such as IC In view of easy handling and promotion of the use, the functions are preferably stored and read from programs or recording media, and further, an arrangement where a computing unit such as computer serves as an information processor (CPU) and the recording/reproducing device 200 can be realized with ease.

The arrangements and the operating procedures for the present invention may be appropriately modified as long as the scope of the present invention can be attained.

### Advantage of Embodiment

As described above, in the above embodiment, the related keyword related to the keyword included in the request information for receiving by the communicator 210 the contents data of a TV program of a predetermined detail is retrieved, and the program information 410 is searched from the program information 410 that includes at least one of the keyword and the related keyword, in accordance with the priority being associated with the related keyword. Thus, since the priority is set for the related keyword related to the keyword for preventing incomplete receiving, the program information can be detected with the detail depending on the priority of the related keyword in relation to the keyword, which can prevent the program information 410 from being improperly searched, so that a control for retrieving the proper contents data can be obtained.

The priority application Number JP2004-164936 upon which this patent application is based is hereby ed by reference.

1. An information processor for retrieving information of a predetermined detail based on detail information about a detail of the information by an information retriever, the information processor comprising:
a request information retriever for retrieving request information including keyword information corresponding to the predetermined detail, the request information requesting retrieval of the information of the predetermined detail by the information retriever;
a related keyword retriever for retrieving related keyword information about a related keyword related to a keyword of the keyword information of the request information;
a priority information retriever for retrieving priority information about a priority of the related keyword;
a detail information searching unit for searching, based on the priority information, the detail information of the detail including at least one of the keyword of the keyword information in the request information and the related keyword of the related keyword information in accordance with the priority; and
an information retrieval controller for controlling the information retriever to retrieve the information based on the searched detail information.

2. The information processor according to claim 1, wherein
the related keyword retriever retrieves the related keyword information associated with the keyword information of the request information based on related word information storage area having a table structure that records a plurality of related word information having a data structure in which the related keyword information about the related keyword related to the keyword is associated with the keyword information.

3. The information processor according to claim 2, wherein
the priority information retriever reads and retrieves priority information associated with the related word information in the related word information storage area.

4. The information processor according to claim 1, wherein
the related keyword retriever retrieves the detail information including the keyword of the keyword information in the request information and extracts the keyword included in the retrieved detail information to obtain the related keyword.

5. The information processor according to claim 1, wherein
the priority information retriever includes a word frequency computer for computing frequency information about an appearance frequency of the related keyword included in the detail information corresponding to the information retrieved by the information retriever, and a priority setting unit for setting the priority based on the frequency information.

6. The information processor according to claim 5, wherein
the word frequency computer computes the frequency information by computing the appearance frequency of the related keyword based on a retrieval history of the information retrieved by the information retriever.

7. The information processor according to claim 1, wherein
the priority information retriever includes a word frequency computer for computing frequency information about an appearance frequency of the related keyword included in the detail information corresponding to the information processed by information processing unit that performs processing of the information, and a priority setting unit for setting priority based on the frequency information.

8. The information processor according to claim 7, wherein
the word frequency computer computes the frequency information by computing the appearance frequency of the related keyword based on a processing history of the information by the information processing unit.

9. The information processor according to claim 5, wherein
the priority setting unit lowers the priority when the appearance frequency of the related keyword corresponding to the frequency information that is computed by the word frequency computer is not updated for a predetermined period of time.

10. The information processor according to claim 1, wherein
the detail information searching unit includes: a detail priority computer for computing detail priority information about detail priority of the detail in the detail information based on the priority, the detail including at least one of the keyword of the keyword information in the request information and the related keyword of the related keyword information; and a detail information selecting unit for selecting the detail information based on the detail priority information.

11. The information processor according to claim 1, wherein
the detail information retriever includes a distribution-time recognizer for recognizing distribution time information about a distribution time or transmission time of the information of the detail information to be searched, a judging unit for judging overlap state of the distribution time based on the distribution time information, and detail information choosing unit for choosing one of detail information from the detail information that are judged by the judging unit to have overlapped distribution times in accordance with the priority.

12. The information processor according to claim 1, wherein
the information retrieval controller includes a storable area recognizer for recognizing a storable area in a storage for storing the information retrieved by the information retriever, and a detail information specifying unit for specifying the detail information searched by the detail information searching unit in accordance with the size of the recognized storable area.

13. The information processor according to claim 1, further comprising
a notification controller for controlling a notifying unit to notify the detail information searched by the detail information searching unit, the keyword information and the related keyword information in a manner selectable by an input operation,
wherein the information retrieval controller controls the information retriever to retrieve the information based on the detail information selected by the input operation.

14. The information processor according to claim 1, further comprising
an information deletion controller for controlling deleting of the information performed by an information deleting unit based on the priority for deleting the information stored in a storage for storing the information retrieved by the information retriever.

15. The information processor according to claim 14, further comprising
a notification controller for controlling a notifying unit to notify that the information is to be deleted by the information deleting unit,
wherein the information deletion controller, when recognizing that request information is input for deleting the information based on notification by the notifying unit, controls the information deleting unit to delete the information.

16. The information processor according to claim 14, wherein
the priority information retriever includes a priority adjuster for lowering priority of a related keyword corresponding to the information deleted by the information deletion controller.

17. The information processor according to claim 13, wherein
the notification controller performs notification by a notifying form according to the priority information.

18. The information processor according to claim 1, wherein
the information is one of a contents that is broadcasted or distributed and a contents that is created by an individual and sharable, and
the detail information is information about at least one of a name and a detail of the contents.

19. An information retrieving device, comprising:
the information processor according to claim 1; and
an information retriever for retrieving the information.

20. An information processing method in which a computing unit retrieves information of a predetermined detail based on detail information about a detail of the information by an information retriever, method comprising the steps of:
retrieving keyword information about a keyword corresponding to the predetermined detail included in request information for retrieving the information of the predetermined content by the request information retriever;
recognizing related keyword information about a related keyword related to the keyword of the keyword information;
recognizing priority information about a priority of the related keyword of the recognized related keyword information;
searching, based on the recognized priority information, the detail information of the detail including at least one of the keyword of the keyword information in the request information and the related keyword of the recognized related keyword information in accordance with the priority; and
controlling the information retriever to retrieve the information based on the searched detail information.

21. An information processing program that operates a computing unit to function as an information processor for retrieving information of a predetermined detail based on detail information about a detail of the information by an information retriever, the information processor including:
a request information retriever for retrieving request information including keyword information corresponding to the predetermined detail, the request information requesting retrieval of the information of the predetermined detail by the information retriever;
related keyword retriever for retrieving related keyword information about a related keyword related to a keyword of the keyword information of the request information;
a priority information retriever for retrieving priority information about a priority of the related keyword;
a detail information searching unit for searching, based on the priority information, the detail information of the detail including at least one of the keyword of the keyword information in the request information and the related keyword of the related keyword information in accordance with the priority; and
an information retrieval controller for controlling the information retriever to retrieve the information based on the detail information the searched detail information.

22. An information processing program that operates a computing unit to execute an information processing method for retrieving information of a predetermined detail based on detail information about a detail of the information by an information retriever, the method including the steps of:
retrieving keyword information about a keyword corresponding to the predetermined detail included in request information for retrieving the information of the predetermined content by the request information retriever;
recognizing related keyword information about a related keyword related to the keyword of the keyword information;
recognizing priority information about a priority of the related keyword of the recognized related keyword information;
searching, based on the recognized priority information, the detail information of the detail including at least one of the keyword of the keyword information in the request information and the related keyword of the recognized related keyword information in accordance with the priority; and
controlling the information retriever to retrieve the information based on the searched detail information.

23. A recording medium storing an information processing program in a manner readable by a computing unit, the program operating the computing unit to function as an information processor for retrieving information of a predetermined detail based on detail information about a detail of the information by an information retriever, the information processor including:
a request information retriever for retrieving request information including keyword information corresponding to the predetermined detail, the request information requesting retrieval of the information of the predetermined detail by the information retriever;
related keyword retriever for retrieving related keyword information about a related keyword related to a keyword of the keyword information of the request information;
a priority information retriever for retrieving priority information about a priority of the related keyword;
a detail information searching unit for searching, based on the priority information, the detail information of the detail including at least one of the keyword of the keyword information in the request information and the related keyword of the related keyword information in accordance with the priority; and
an information retrieval controller for controlling the information retriever to retrieve the information based on the detail information the searched detail information.

24. A recording medium storing an information processing program in a manner readable by a computing unit, the program operating the computing unit to execute an information processing method for retrieving information of a predetermined detail based on detail information about a detail of the information by an information retriever, the method including the steps of:
retrieving keyword information about a keyword corresponding to the predetermined detail included in request information for retrieving the information of the predetermined content by the request information retriever;
recognizing related keyword information about a related keyword related to the keyword of the keyword information;
recognizing priority information about a priority of the related keyword of the recognized related keyword information;
searching, based on the recognized priority information, the detail information of the detail including at least one of the keyword of the keyword information in the request information and the related keyword of the recognized related keyword information in accordance with the priority; and
performing a processing for retrieving the information based on the searched detail information by the information retriever.
